(19) United States
(12) Patent Application Publication
(10) Pub. No.: US 2016/0212950 A1
(43) Pub. Date: Jul. 28, 2016

(54) LIFTING AND SUPPORT SYSTEM FOR PALM TREES

(71) Applicant: Briones Ortuño JOSÉ, Caudete (ES)

(72) Inventor: Briones Ortuño JOSÉ, Caudete (ES)

(21) Appl. No.: 15/023,690

(22) PCT Filed: Aug. 14, 2014
(86) PCT No.: PCT/ES2014/070657

§ 371 Date: Mar. 22, 2016

(30) Foreign Application Priority Data
Sep. 26, 2013 (ES) P201331403

(51) Int. Cl. A01G 17/10; A01G 9/12

(52) U.S. Cl. CPC A01G 17/10; A01G 9/12

(57) ABSTRACT

The invention relates to a system for applying to the trunk (4) of a palm tree, serving as a lifting and holding means for the leaves (3) thereof, or as a support means for additional plants, of the climbing type or other types, or even for supporting elements such as photovoltaic plates, wind generators, antennae etc. The system is based on the arrangement of two rings (1) and (2) on the trunk (4) of the palm tree, ring (1) being the one which is fixed to the trunk, and having an adjustable contour so as to be able to adapt to the increasing thickness of the trunk (4) of the palm tree as it grows, or being fixed and applied to the fully grown trunk, while ring (2) is suspended in relation to the previous one and is wider, the two rings (1 and 2) being connected by means of suitable struts (5) that are length-adjustable or fixed, deformable or rigid, and complemented by a third stabilisation ring (6) which is connected to the lifting ring (2) by means of struts (7), the contour of said stabilisation ring (6) also being adjustable or fixed.

### OBJECT OF THE INVENTION

The present invention relates to a lifting and support system for palm trees, intended for the lifting and support of the leaves of a palm tree, starting at a higher area of the trunk of the palm tree itself, or as a means of support for other plants, such as those of the climbing type, or even for the leaves resulting from the lopping of the palm tree, in which case the system is applied to an intermediate, lopped area of the trunk of any type of palm tree to which it is applied.

The object of the invention is to preserve the support of the higher leaves of palm trees and to exploit the holding of said leaves in order to cast a natural, hardy and lasting shade, at the desired height on the trunk, using the same trunk of the palm tree itself as a stand, thus enabling the natural growth of said tree above the system applied, but with the leafy splendour ever higher.

### BACKGROUND OF THE INVENTION

No systems are known with the characteristics, application or functions of the system which is the object of the present invention.

### DESCRIPTION OF THE INVENTION

The system which is the object of the invention is foreseen for its application on the trunk of a palm tree, either at an area below the upper leaves of the tree, or at an area of the trunk devoid of leaves due to a prior lopping of said trunk.

More specifically, the system of the invention is based on the arrangement of two rings, one for its affixing at the desired area of the trunk of the palm tree, being self-adjustable to that area as the trunk grows, and another of a greater contour which is located hanging from the first, that is, at a lesser height.

The affixing ring shall be preferably circular, its contour being self-adjustable, and is positioned at the base of the highest leaves of the palm tree and, as its denomination indicates, it is intended for the performance of the affixing on the trunk, while the supporting ring may be circular or of any other polygonal, preferably regular, shape and will hold the leaves which the palm tree gradually allows to droop.

In a preferred embodiment, the rings are interconnected by means of length-adjustable struts, to enable a greater or lesser distance between the two; alternatively, the struts may be rigid and therefore invariable in length, the distance between rings consequently also being invariable; these rings may even be linked by means of adjustable struts combined with a structure of stabilising cross-members.

It should likewise be mentioned that the affixing ring may feature a fixed diameter, which shall correspond to that of the trunk of the palm tree, when said trunk is fully developed, although, as has been mentioned above, the affixing ring should preferably be self-adjustable, that is, its contour will increase as the contour of the palm tree trunk grows or increases, it being possible for said affixing ring to be formed by a number of different elements, and in all cases being a ring able to open and close upon itself for its placement on and adaptation to the palm tree trunk on which it is applied.

The two said rings, that of affixing and that of supporting, may be supplemented by a third ring, denominated the stabilising ring, which is connected to the first two rings by means of adjustable struts (flexible or rigid), it being possible for said third stabilising ring to feature the same characteristics (adjustable or rigid, openable and closable, etc.) as those of the affixing ring.

Said stabilising ring shall be adaptedly located on the contour of the trunk, at the same height as that of the supporting ring or at a lower height, with rigid struts for its linking to the supporting ring.

Another characteristic, as an alternative to the embodiment, is that the affixing ring may be rotatory, be its contour self-adjustable or fixed.

With regard to the supporting ring, irrespective of its linking to the affixing ring by means of flexible or rigid struts, and of its linking, also by struts of the same characteristics, to the stabilising ring, it may be supported by means of rigid elements by way of pillars anchored in the ground, either vertical or converging, or pillars convergingly anchored to the affixing ring located at a height lower than that of the supporting ring.

In another variant of an embodiment, the system or assembly formed by the affixing ring and the supporting ring, or even when supplemented by the stabilising ring, is located on a section of trunk devoid of leaves, forming an intermediate support between the ground and the leaves to act as a support for climbing plants, artificial plants, or even the leaves derived from the lopping of the palm tree.

In this variant of an embodiment the rings may be interconnected by means of flexible or rigid struts at different heights, to form a load-bearing structure, etc.; in all cases, the affixing and stabilising rings may feature an adjustable or fixed contour.

In another variant of an embodiment the affixing ring may be rotatory, as may the entire assembly, in such a way that, be it fixed or rotatory, it may act as a support, for example, for solar panels, photovoltaic cells, solar heaters, wind turbine generators, weather stations, weathervanes, aerials, tables, seats, etc.

Specifically, and with regard to the disclosure of the preceding paragraph, the affixing ring shall be located on a smooth area or stretch of the palm tree trunk, that is, a stretch that has been lopped and is devoid of leaves, when the trunk is totally developed, in such a way that the ring in question, when rotatory, may move in an upward or downward direction, either manually or automatically, the same occurring with the stabilising ring, should this be included in the system.

### DESCRIPTION OF THE DRAWINGS

As a supplement to the description to be made below, and for the purpose of aiding the better understanding of the characteristics of the invention, a set of drawings is attached to this specification as an integral part of the same, wherein, by way of illustration and not limitation, the following is portrayed:

FIG. 1 portrays a drawing corresponding to a schematic perspective view of the application of the system of the invention on the trunk of a palm tree, wherein the system is formed by two rings affixed to respective areas of the trunk, and a ring of greater diameter, the three rings being interconnected by means of struts, which may be adjustable (flexible or rigid).

FIG. 2 portrays a schematic perspective view of the system assembly featuring the affixing ring and the supporting ring, connected to each other by the combination of adjustable struts and by rigid stabilising cross-members.

FIG. 3 portrays a variant of an embodiment wherein the system is formed by the two rings affixed on the trunk of the palm tree, linked to the supporting ring by means of pillars or brackets and rigid struts anchored to the affixing ring, combined with struts (flexible or fixed).

FIG. 4 portrays a drawing similar to that of FIG. 2, but in this case with the struts linking the affixing ring and the supporting ring being adjustable in length, and the supporting ring is held by props by way of pillars vertically or convergingly anchored in the ground.

FIG. 5 portrays a perspective view of another alternative for the application of the system on a stretch of the trunk of the palm tree which is totally smooth, that is, devoid of leaves, due to its prior lopping.

FIG. 6 portrays an alternative to the embodiment similar to that of the previous figure, but in this case with the affixing ring constituting a support, for example for wind turbine generators, and the structure of the system constituting a multi-purpose support.

Finally, FIG. 7 portrays a schematic perspective view of different applications of the system of the invention, all of these on the lopped trunk of a palm tree, forming a multi-purpose supporting structure, a supporting structure for lamps, a supporting structure for a table, etc.

### PREFERRED EMBODIMENT OF THE INVENTION

As may be seen in the aforementioned figures, the system of the invention is comprised of an affixing ring (1) and a supporting ring (2), the first of these foreseen for its placement below the upper leaves (3) of a palm tree with its trunk (4) lopped below said leaves (3), in such a way that said affixing ring (1) may feature a self-adjustable contour so as to adapt to the contour of the trunk (4) as it develops, or the contour of said ring (1) may be fixed, in which case it should be applied to a fully developed trunk (4).

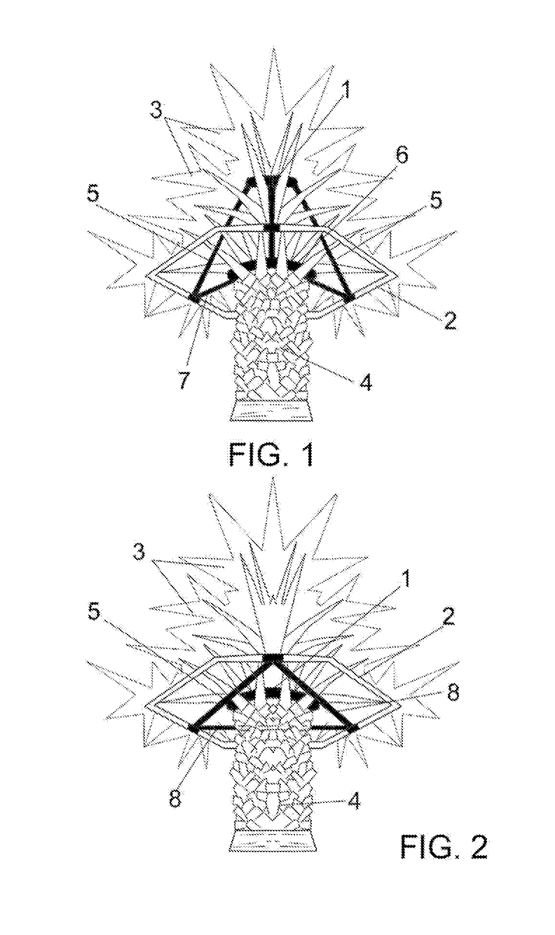

In all cases, the supporting ring (2) features a larger contour, and may be circular or of a regular polygonal shape, as portrayed in FIG. 1 and other figures, specifically a regular hexagonal shape.

Furthermore, the aforementioned affixing ring (1) and supporting ring (2) are linked to each other by means of struts (5), by means of which the ring (2) is held by the ring (1); said struts (5) may be adjustable in length or rigid, that is, flexible or rigid.

FIG. 1 further reveals the inclusion of a third ring (6), denominated stabilising ring, which may be located at the same height, above or below the supporting ring (2), in such a way that said stabilising ring (6) is also assembled on the trunk (4) of the palm tree, with an adjustable or fixed contour as in the case of the affixing ring (1), said stabilising ring (6) being linked to the supporting ring (2) by means of struts (7) which may be adjustable (flexible or rigid), as is the case with the struts (5) mentioned above.

In the portrayal of FIG. 2, the system incorporates the affixing ring (1) and the supporting ring (2), it being possible for said rings (1 and 2) to feature the same characteristics as those mentioned for FIG. 1, in such a way that in the case of FIG. 2; the two rings (1 and 2) are linked to each other by means of struts (5) which are adjustable in length, and also by means of a structure of cross-members (8) connected to the supporting ring (2) and which are linked to the length-adjustable struts (5), in this case the system being devoid of a stabilising ring (6).

As in the variants of the embodiments to be described below, the materials constituting both the struts and the rings shall be either flexible or rigid, resistant materials.

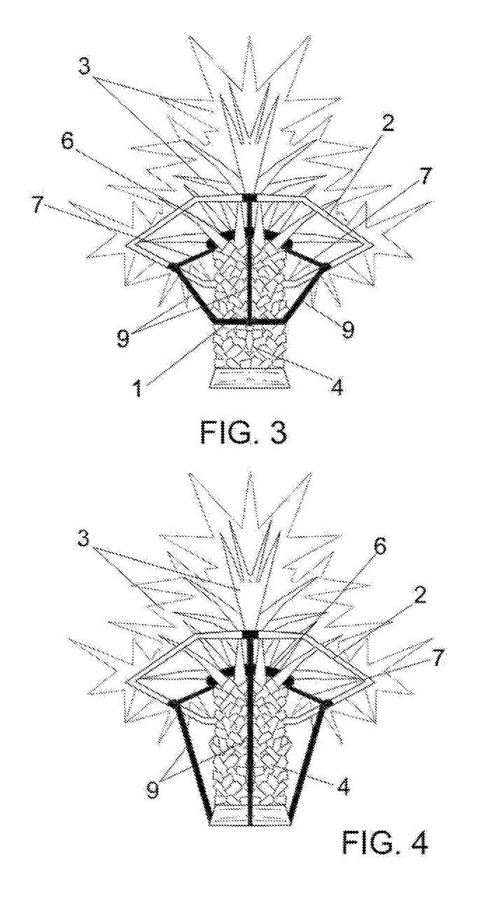

In the variant of the embodiment portrayed in FIG. 3, which includes the affixing ring (1) and stabilising ring (6) as well as the supporting ring (2), the struts (7) are depicted; these may be fixed or adjustable, and in this case the struts linking the supporting ring (2) to the affixing ring (1) are rigid brackets or pillars.

In the same way as in the previous cases, the affixing ring (1) and the stabilising ring (6) may feature an adjustable or fixed contour.

FIG. 4 portrays another variant of an embodiment of the system, with the stabilising ring (6) and the supporting ring (2), featuring either of the aforementioned characteristics, and the struts (7) linking both.

In this case it may be seen how the supporting ring (2) is held by means of a number of pillars (9) anchored in the ground; in the case depicted said pillars converge in a downward direction, that is, slanting, although said supporting or bracing pillars (9) may also be vertical.

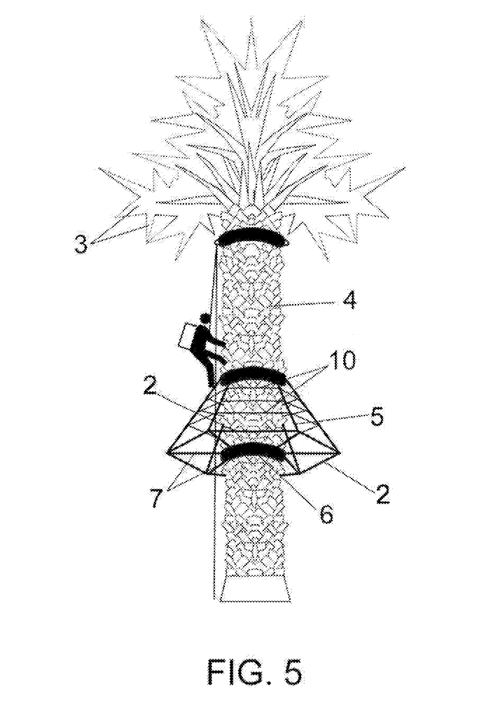

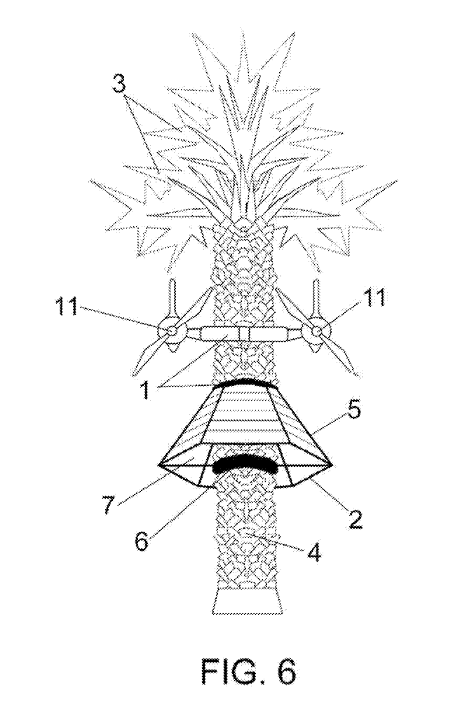

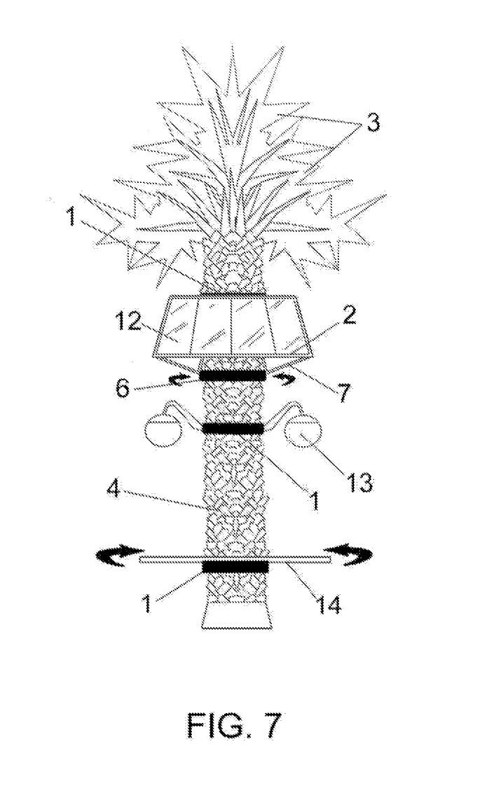

In the variant of the embodiment portrayed in FIG. 5, the assembly or structure forming the system of the invention is applied to a stretch of trunk (4) which is devoid of leaves, that is, smooth or lopped, where the affixing ring (1) and stabilising ring (6) may, as in the previous cases, be adjustable in contour in order to adapt to the trunk (4) as this grows, or be fixed, to be applied to trunks (4) which are fully developed. These rings (1 and 6) are linked to the supporting ring (2) by means of their respective struts (5 and 7), as has been mentioned above, with the distinctive feature that in this case the struts (5) incorporate between each other a further number of rigid or flexible struts (10) to form a structure which as a whole may act as a support for artificial plants, climbing plants, or even for leaves lopped from the palm tree itself, or for any other use.

In accordance with another characteristic of the invention, the affixing ring (1) may, as may the remainder of the structure, that is, the stabilising ring (6) and therefore the supporting ring (2) with the struts (5 and 7), be fixed or rotatory, may feature an adjustable or fixed contour, as has been stated above, and in all cases the affixing ring (1) may serve as a support for items such as wind turbine generators (11) or, in combination with the stabilising ring (6) and the supporting ring (2), may form a supporting structure such as that mentioned for FIG. 5, or as an anchor point for climbing means and lifelines for the assembly and maintenance personnel of the systems installed.

Last, FIG. 7 portrays different applications of the system of the invention, forming a structure, for example, for the support of photovoltaic panels (12), a structure for lamps (13), a structure for tables (14), etc., and in all cases these structures may be constituted directly by the affixing ring (1) itself, combined or not with the supporting ring (2) and the stabilising ring (6), it being possible for said rings (1 and 6) to be rotatory and therefore the supporting ring (2) likewise, for different uses or applications such as those mentioned above and other similar uses.

Finally, it should be said that the rings (1 acid 6) may be formed by a ring open on one side and of a flexible material, or by two half-rings attached together, either of a self-adjusting nature with regard to their contour, or of a fixed nature for their direct application on fully-developed trunks (4), as has been stated throughout this description.

1. A lifting and support system for palm trees, foreseen to support the leaves of a palm tree which droop below a certain height, or to support other materials such as climbing plants or even the leaves derived from the lopping of the same palm tree to which it is applied, characterised in that it comprises at least one or two rings (1 and 2), the first as a ring for its affixing on the trunk (4) of the palm tree, corresponding to an area located below the upper leaves (3) of the same, while the second ring (2) is a supporting means and features a greater contour than the first, being located below the affixing ring (1), for the support and holding of leaves which the palm tree will allow to droop, with the distinguishing feature that both the affixing ring (1) and the supporting ring (2) are linked to each other by means of struts (5).

2. A lifting and support system for palm trees, as claimed in claim 1, characterised in that it features a third stabilising ring (6) located below the affixing ring (1) and linked to said affixing ring (1) and supporting ring (2) by means of struts (7).

3. A lifting and support system for palm trees, as claimed in claims 1 and 2, characterised in that the struts (5) linking the affixing ring (1) and the supporting ring (2), and likewise the struts (7) linking the supporting ring (2) and the stabilising ring (6) are adjustable in length, flexible or rigid.

4. A lifting and support system for palm trees, as claimed in claims 1 and 2, characterised in that the struts (5) linking the affixing ring (1) and the supporting ring (2), and likewise the struts (7) linking the supporting ring (2) and the stabilising ring (6) are of constant length or fixed.

5. A lifting and support system for palm trees, as claimed in claims 1 and 2, characterised in that the affixing ring (1) and the stabilising ring (6) feature a self-adjustable contour, to adapt to the contour of the trunk (4) of the palm tree during the development of said trunk (4).

6. A lifting and support system for palm trees, as claimed in claims 1 and 2, characterised in that the affixing ring (1) and the stabilising ring (6) feature a fixed contour, to adapt to the contour of the fully-developed trunk (4) of the palm tree.

7. A lifting and support system for palm trees, as claimed in preceding claims, characterised in that the affixing ring (1) and the stabilising ring (6) are open for their placement on the trunk (4) of the palm tree, and feature a closing means for their placement on said trunk (4).

8. A lifting and support system for palm trees, as claimed in preceding claims, characterised in that the supporting ring (6) incorporates a structure of rigid cross-members (8) by means of which said supporting ring (2) is interconnected with the struts (5) forming the link to the affixing ring (1).

9. A lifting and support system for palm trees, as claimed in preceding claims, characterised in that the supporting ring (2) rests upon rigid elements in the manner of pillars (9) anchored in the ground, or to the affixing ring (1), located at a lower height, in the manner of slanting pillars or brackets.

10. A lifting and support system for palm trees, as claimed in preceding claims, characterised in that the affixing ring (1) and, where applicable, the stabilising ring (6), are located on a stretch of the trunk (4) of the palm tree which is devoid of leaves, between the ground and the upper leaves (3), while the supporting ring (2) is linked to said affixing ring (1) and stabilising ring (2) by means of struts between which other transversal struts (10) are arranged to form a structure located on the stretch devoid of leaves of the trunk (4) of the palm tree, and to serve as a support for artificial plants, climbing plants or any other type of plant.

11. A lifting and support system for palm trees, as claimed in preceding claims, characterised in that the affixing ring (1) and, where applicable, the stabilising ring (6), are rotatory with regard to the trunk (4) of the palm tree, it being possible for said rings (1 and 6) to feature a self-adjustable contour, or a fixed contour and formed by two half-rings attached to each other, or by a single ring open on one side only and made of a flexible material, said rings (1 and 6) being assembled on a stretch of the trunk (4) of the palm tree which is devoid of leaves.

12. A lifting and support system for palm trees, as claimed in claim 11, characterised in that the affixing ring (1) and the stabilising ring (6), whether fixed or rotatory, feature a rack and a guide for the manual or automatic displacement in an upward or downward direction of said rings (1 and 6) on the trunk (4) of the palm tree on which they are installed.

13. A lifting and support system for palm trees, as claimed in claims 11 and 12, characterised in that the affixing ring (1) and the stabilising ring (6), whether fixed or rotatory, are equipped with any type of anchor point or accessory which may be necessary for the assembly of any of the systems, such as a guide and a rack for the rotatory model, or anchor points to provide climbing means, for the safety of personnel during installation or maintenance.

14. A lifting and support system for palm trees, as claimed in claims 10 to 12, characterised in that the structure formed by the affixing ring (1) with the supporting ring (2) and, where applicable, the stabilising ring (6) constitutes a fixed or rotatory support for photovoltaic cells, solar heaters, wind turbine generators, weather stations, aerials, lamps, tables, seats and the like.
